(19) United States
(12) Patent Application Publication
(10) Pub. No.: US 2012/0162018 A1
(43) Pub. Date: Jun. 28, 2012

(54) Thin-Film Antenna

(75) Inventors: Chiu Tsung-Wen, Taipei County (TW); Hsiao Fu-Ren, Taipei County (TW); Chen Po-Sheng, Taipei County (TW)

(73) Assignee: ADVANCED CONNECTEK, INC., Taipei County (TW)

(21) Appl. No.: 13/153,222

(22) Filed: Jun. 3, 2011

(30) Foreign Application Priority Data
Dec. 24, 2010 (TW) 099145735

(51) Int. Cl. H01Q 1/38

(52) U.S. Cl. 343/700 MS

(57) ABSTRACT

A thin-film antenna comprises a plastic member, a flexible radiation conductor and a conduction member. The plastic member has an accommodation space. The flexible radiation conductor is disposed on one surface of the accommodation space. The conduction member has a contact terminal physically contacting the flexible radiation conductor. The flexible radiation conductor is embedded on one surface of the accommodation space of the plastic housing of a wireless communication device via a hot pressing process. The flexible radiation conductor can replace the conventional complicated rigid metallic radiation conductor to reduce thickness of products. The conduction member has a conductive metallic thimble for conducting electric signals, which can prevent the thin-film radiation conductor from protruding or breaking. The superior pliability and bendability of the flexible radiation conductor enables the flexible radiation conductor to integrate with an arbitrary surface, such as a complicated surface or a curved surface.

### BACKGROUND OF THE INVENTION

1. Field of the Invention

The present invention relates to a thin-film antenna, particularly to an antenna having a thin-film flexible radiation conductor.

2. Description of the Related Art

The embedded antenna has evolved from a single and narrow band system to a multi and broad band system. The elements of a multiband system should be miniaturized as much as possible. Such a requirement makes the realization of a multiband system more complicated. The consumers have a bias for wireless communication devices with a smooth and neat appearance. Therefore, the appearance design and integration capability of a multiband antenna become a big challenge.

However, when the contact terminals conducting electric signals are inserted into the holes of a plastic housing in the practical fabrication process, they are likely to bump the radiation conductors and the thin film because the operator is hard to control the inserting force. Thus, the radiation conductors may be damaged, and the thin film may be bulged. Then, the antenna may malfunction.

### SUMMARY OF THE INVENTION

One objective of the present invention is to provide a thin-film antenna, wherein a thin-film flexible radiation conductor is disposed on a surface of an accommodation space of a plastic member of a wireless communication device, and wherein the pattern of the radiation conductor is fabricated on the surface of a soft substrate with an etching process, and wherein the substrate is extended into a 3D shape at high temperature, and whereby the flexible radiation conductor can be embedded in a plastic material or integrated with an object having an arbitrary surface, such as a complicated surface or a curved surface.

Another objective of the present invention is to provide a thin-film antenna, wherein a flexible radiation conductor replaces a rigid one to reduce the overall thickness of a product, and wherein a conductive metallic thimble of a conduction member is used to prevent the thin-film flexible radiation conductor from protruding or breaking, whereby is decreased the fabrication cost and promoted the yield rate.

To achieve the abovementioned objectives, the present invention proposes a thin-film antenna, which comprises a plastic member, a flexible radiation conductor and a conduction member. The plastic member has an accommodation space. The flexible radiation conductor is disposed on one surface of the accommodation space. The conduction member has a contact terminal physically contacting the flexible radiation conductor.

The present invention is characterized in replacing the conventional rigid metallic radiation conductor with a thin-film flexible radiation conductor. The flexible radiation conductor is fabricated via using a photolithographic process and an etching process to form a pattern of the flexible radiation conductor on a soft substrate, and extending the substrate into a 3D shape at high temperature and under high pressure. Thereby, the flexible radiation conductor has superior pliability and bendability. The finished flexible radiation conductor can be stuck onto an arbitrary surface of an object, such as a complicated surface or a curved surface. Alternatively, the finished flexible radiation conductor is disposed inside an injection mold beforehand, and then embedded in a plastic member via injection molding.

Via replacing the conventional rigid metallic radiation conductor with a thin-film flexible radiation conductor and disposing the thin-film flexible radiation conductor on a surface of an accommodation space of a plastic member, the present invention can greatly reduce the overall thickness of a product. Further, the present invention uses a conductive metallic thimble of a conduction member to prevent the thin-film radiation conductor from protruding or breaking. Thereby is promoted the yield rate of products.

In a second embodiment of the present invention, the flexible radiation conductor is completely airtightly embedded on an inner surface of an accommodation space of a plastic member; a through-hole interconnects exterior and interior of the plastic member and contacts an interface of the flexible radiation conductor; a conduction member having a contact terminal is inserted into the through-hole to physically contact the flexible radiation conductor. Thereby is formed an antenna with the flexible radiation conductor thereof embedded inside a plastic member.

In a third embodiment of the present invention, the flexible radiation conductor is disposed on the upper outer surface or lower outer surface of a plastic member; a contact terminal of a conduction member physically contacts the flexible radiation conductor. Thereby is formed an antenna with the flexible radiation conductor thereof able to integrate with a surface of an arbitrary object.

Below, the embodiments are described in detail to make easily understood the technical contents of the present invention.

### BRIEF DESCRIPTION OF THE DRAWINGS

FIG. 1 is a perspective exploded view schematically showing a thin-film antenna according to a first embodiment of the present invention;

FIG. 2 is an assembling drawing schematically showing the thin-film antenna according to the first embodiment of the present invention;

FIG. 3 is a side view schematically showing the thin-film antenna according to the first embodiment of the present invention;

FIG. 4 is a perspective exploded view schematically showing a thin-film antenna according to a second embodiment of the present invention;

FIG. 5 is an assembling drawing schematically showing the thin-film antenna according to the second embodiment of the present invention;

FIG. 6 is a side view schematically showing the thin-film antenna according to the second embodiment of the present invention; and

FIG. 7 is a side view schematically showing a thin-film antenna according to a third embodiment of the present invention.

### DETAILED DESCRIPTION OF THE INVENTION

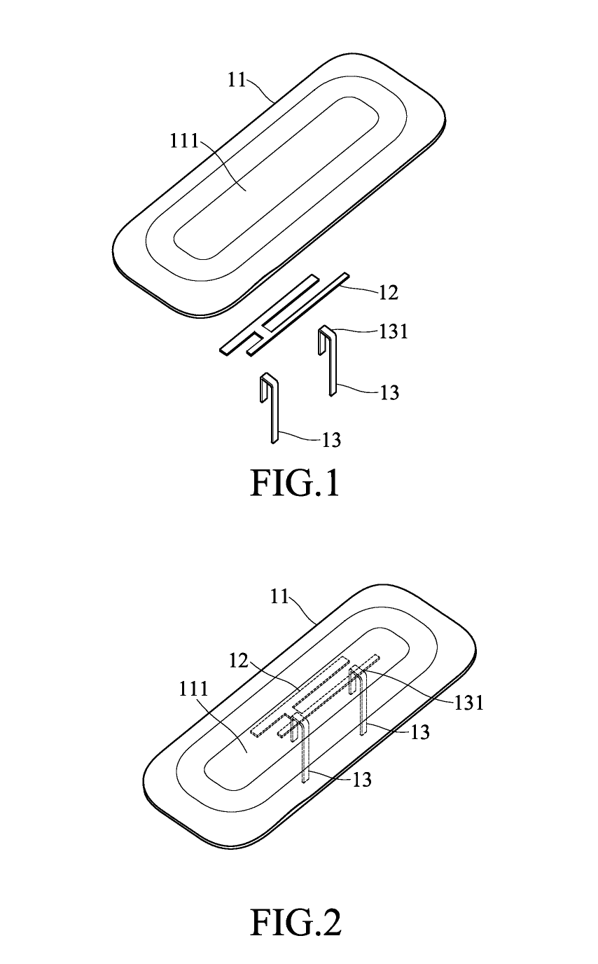

Refer to FIG. 1 and FIG. 2 respectively a perspective exploded view and an assembling drawing of a thin-film antenna according to a first embodiment of the present invention. In the first embodiment, the thin-film antenna comprises a plastic member 11, a flexible radiation conductor 12, and a conduction member 13. The plastic member 11 has an accommodation space 111. The flexible radiation conductor 12 is embedded on one surface of the accommodation space 111 of the plastic member 11. The conduction member 13 has a contact terminal 131 physically contacting the flexible radiation conductor 12.

In the first embodiment, the plastic member 11 is made of a non-conductive material, such a plastic housing of a mobile phone or a notebook computer. The flexible radiation conductor 12 has superior pliability and bendability and can be pre-disposed in the inner surface of the accommodation space 111 of the plastic member 11 completely airtightly or disposed on the upper/lower outer surface of the accommodation space 111 of the plastic member 11. In the first embodiment, the flexible radiation conductor 12 is embedded on the lower outer surface of the accommodation space 111 of the plastic member 11. A contact terminal 131 of the conduction member 13 physically contacts the flexible radiation conductor 12. The conduction member 13 is a conductive metallic thimble for conducting electric signals.

In the first embodiment, the plastic member 11 has an about rectangular shape with a length of about 70 mm, a width of about 28 mm, and a thickness of about 0.05 mm. The accommodation space 111 is located at the center of the plastic member 11 and has a length of about 40 mm and a width of about 8 mm. The flexible conductor 12 has an H-like shape. The rectangle of the H-like shape, which does not contact the conduction member 13, has a length of about 24 mm, a width of about 2 mm and a thickness of about 0.02 mm. The rectangle of the H-like shape, which contacts the conduction member 13, has a length of 28 mm, a width of about 1.5 mm and a thickness of about 0.02 mm. The middle rectangle of the H-like shape has a length of about 3 mm, a width of about 2 mm and a thickness of about 0.02 mm. The conduction member 13 has a J-like shape. The long rectangle of the J-like shape has a length of about 8 mm and a width of about 2 mm. The short rectangle of the J-like shape has a length of about 4 mm and a width of about 2 mm. The contact terminal 131 has a length of about 3 mm and a width of about 2 mm.

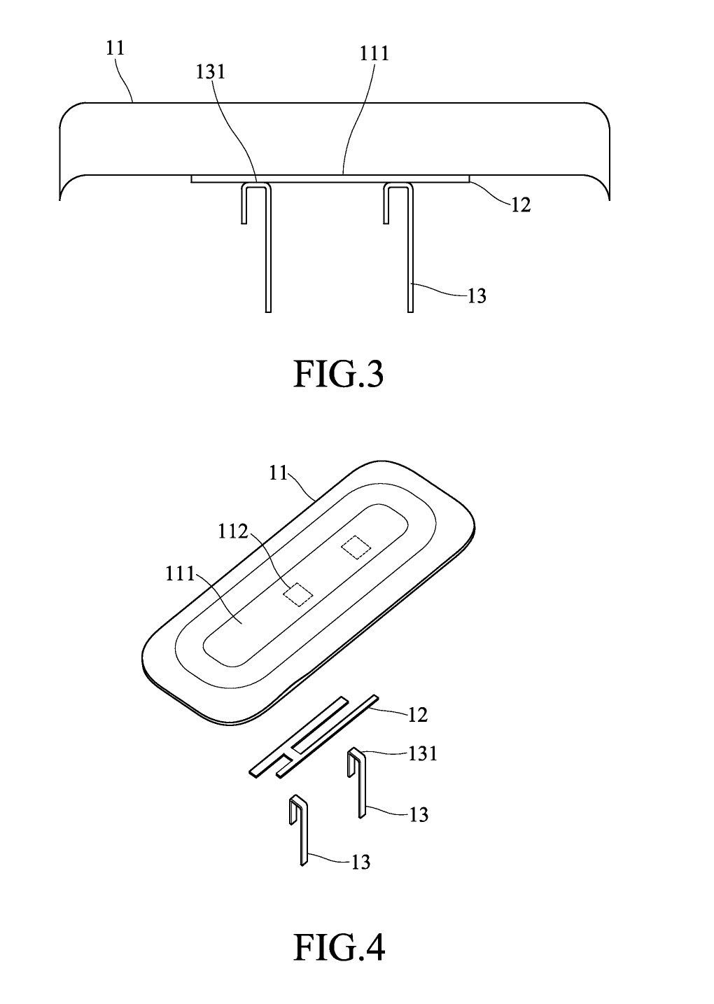

Refer to FIG. 3 a side view of the thin-film antenna according to the first embodiment of the present invention. As the flexible radiation conductor 12 has superior pliability and bendability, it can be closely and smooth stuck onto the lower outer surface of the plastic member 11 when embedded on the lower outer surface.

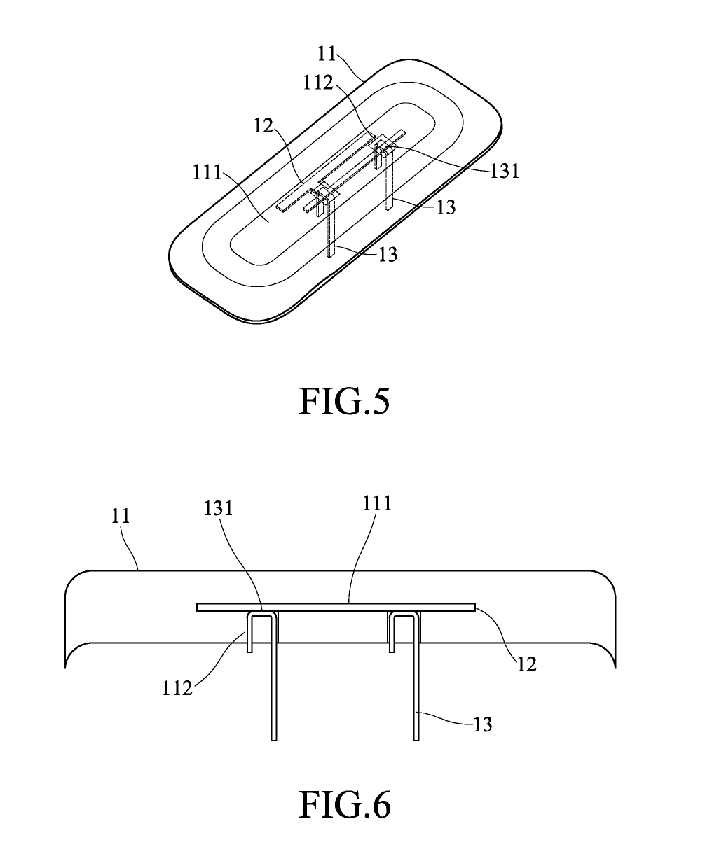

Refer to FIG. 4 and FIG. 5 respectively a perspective exploded view and an assembling drawing of a thin-film antenna according to a second embodiment of the present invention. The second embodiment is basically similar to the first embodiment but different from the first embodiment in that a through-hole 112 is formed on the plastic member 11 when the flexible radiation conductor 12 is completely airtightly embedded on the inner surface of the accommodation space 111 of the plastic member 11. The through-hole 112 interconnects the exterior and interior of the plastic member 11 and contacts an interface of the flexible radiation conductor 12.

Refer to FIG. 6 a side view of the thin-film antenna according to the second embodiment of the present invention. The flexible antenna 12 is arranged inside an injection mold beforehand and completely airtightly embedded on the inner surface of the plastic member 11 after injection molding. The through-hole 112 is pre-stamped in the plastic member 12, allowing the contact terminal 131 of the conduction member 13 to penetrate the plastic member 13 and physically contact the flexible radiation conductor 12. Thereby, electric signals can be conducted by the thimble of the conduction member 13.

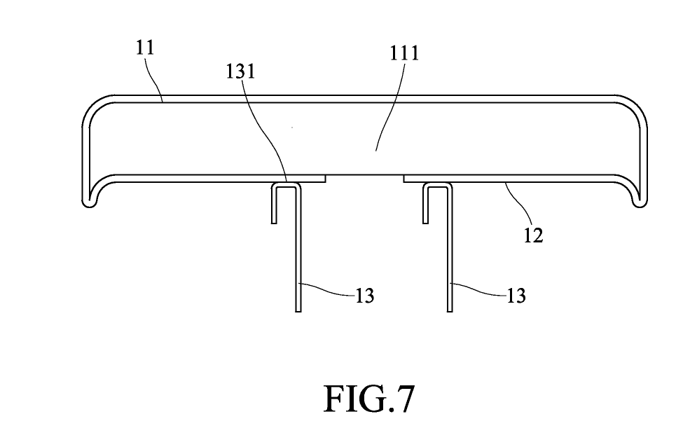

Refer to FIG. 7 a side view of a thin-film antenna according to a third embodiment of the present invention. The third embodiment is basically similar to the first embodiment but different from the first embodiment in that the flexible radiation conductor 12 is embedded on upper outer surface of the accommodation space 111 of the plastic member 11. After having been stuck onto the upper outer surface of the plastic member 11, the flexible radiation conductor 12 extends downward along the two sides to the lower outer surface. Then, the flexible radiation conductor 12 is stuck onto the lower outer surface. In the third embodiment, the contact terminal 131 of the conduction member 13 also physically contacts the flexible radiation conductor 12.

No matter whether the flexible radiation conductor 12 is completely airtightly embedded on the inner surface of the accommodation space 111 or disposed on the upper/lower outer surface of the accommodation space 111, the superior pliability and bendability of the thin-film flexible radiation conductor 12 always enables the radiation conductor pattern to integrate with the surface of the plastic member 11 easily.

The above description has proved that the present invention possesses utility, novelty and non-obviousness and meets the condition for a patent. However, the embodiments described above are only to exemplify the present invention but not to limit the scope of the present invention. Any equivalent modification or variation according to the spirit of the present invention is to be also included within the scope of the present invention.

What is claimed is:

1. A thin-film antenna comprising
a plastic member having an accommodation space;
a flexible radiation conductor disposed on a surface of said accommodation space of said plastic member; and
a conduction member having a contact terminal physically contacting said flexible radiation conductor.

2. The thin-film antenna according to claim 1, wherein said plastic member is made of a non-conductive material.

3. The thin-film antenna according to claim 1, wherein said flexible radiation conductor is completely airtightly embedded on an inner surface of said accommodation space of said plastic member, or disposed on an upper surface or a lower surface of said accommodation space of said plastic member.

4. The thin-film antenna according to claim 1, wherein a through-hole is formed in said plastic member.

5. The thin-film antenna according to claim 4, wherein said through-hole interconnects exterior and interior of said plastic member and contacts an interface of said flexible radiation conductor.

6. The thin-film antenna according to claim 1, wherein said conduction member is a metallic thimble for conducting electric signals.

7. A thin-film antenna comprising
a plastic member having an accommodation space;
a flexible radiation conductor completely airtightly embedded on an inner surface of said accommodation space of said plastic member;
a through-hole interconnecting exterior and interior of said plastic member and contacting an interface of said flexible radiation conductor; and
a conduction member having a contact terminal and inserted from an outer surface of said plastic member into said through-hole to physically contact said flexible radiation conductor via said contact terminal.

8. The thin-film antenna according to claim 7, wherein said plastic member is made of a non-conductive material.

9. The thin-film antenna according to claim 7, wherein said conduction member is a metallic thimble for conducting electric signals.

10. A thin-film antenna comprising
a plastic member having an accommodation space;
a flexible radiation conductor disposed on an outer surface of said accommodation space of said plastic member; and
a conduction member having a contact terminal physically contacting said flexible radiation conductor.

11. The thin-film antenna according to claim 10, wherein said plastic member is made of a non-conductive material.

12. The thin-film antenna according to claim 10, wherein said flexible radiation conductor is integrated with an upper outer surface or a lower outer surface of said accommodation space of said plastic member.

13. The thin-film antenna according to claim 10, wherein said conduction member is a metallic thimble for conducting electric signals.
